(19) United States
(12) Patent Application Publication
(10) Pub. No.: US 2006/0073821 A1
(43) Pub. Date: Apr. 6, 2006

(54) Method and device for simulating a communication on a terminal device

(76) Inventor: Olli Rantapuska, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/533,250

(22) PCT Filed: Oct. 30, 2002
(86) PCT No.: PCT/IB02/04512

§ 371 Date: Apr. 29, 2005

(51) Int. Cl. H04Q 7/20

(52) U.S. Cl. 455/423

(57) ABSTRACT

The present invention relates to a method and a device (20) in a network environment having the capability to exchange data (24) via the communication network (22) and for simulating a communication (26) by generating messages with a minimized use of the communication network. The simulation of the communication is to done on a (mobile) terminal device (22) of a communication network (22), and comprises the detection of an initiation event in the terminal device. Following the detection, the properties of the initiation event are determined, and a simulated message related to the determined properties is generated, wherein the simulated message is generated from data stored in the storage. Finally, the simulated message is presented (26) via a communication functionality of the communication device. The normal communication path (24) of the communication device (20) is not restricted by the simulation.

The present invention relates to a method and a device in a network environment having the capability to exchange data via said communication network. It also relates to a device for simulating a communication by generating messages with a minimized use of the communication network.

Each mobile phone delivers basic telephone capabilities to a user. To give an incentive to buy new telephones, the design and development must focus on further capabilities to simplify the life of the user, as can be seen from personal digital assistants (PDAs) or broadcast radio and telephone combinations. Other incentives have been the integration of media players to provide a radio recorder, dictating machine or a portable compact disc (CD) player functionality to the mobile phone. Other efforts include the integration of digicams (digital cameras), digital video recorders and the like in a mobile phone. Further developments include payment devices. Another effort is to include a gaming application, implemented as games like “Snake”, “Space”, “Pairs”, “rotation” or “Minesweeper” on a mobile phone.

Other approaches to increase the attraction of a mobile phone to a user comprise an “online” or interactive game, wherein a big variety of people can use a communication network to play against each other or a central server. Such applications are e.g. described in the European Patent Application EP 1 066 867 A2 of the applicant. EP 1 066 867 A2 describes a method and an apparatus for playing games between client entities using a communication network. This feature provides a possibility to play games via large distances, but has the drawback that the user has to pay for the connection during the game.

All the above described features cannot solve a basic problem tied to mobile phones, i.e. nobody would like to buy a mobile phone, if there is nobody calling, or sending messages. None of the above gimmicks can replace a non-used basic functionality of a mobile phone, which occurs if nobody is calling.

It is a tendency in the technique and in the society to replace activities requiring private contacts with technical entertainment devices, as can be seen in technical fitness centers replacing outdoor sports, computer games replacing leisure time activities, and the internet replacing direct private contacts.

It is therefore desirable that a telephone can not only deliver the possibility to communicate but also delivers a communication partner, to provide a communication option to the mobile phone. Such a feature would additionally provide a possibility not only to provide the communication channel but also the communication partner.

It is therefore desirable to provide a simulated communication feature to mobile phones.

It is further desirable to provide a simulated communication requiring only a minimum data exchange via a communication network.

According to a first aspect of the present invention a method for simulating communication on a terminal device of a communication network is provided. The terminal device comprises a communication functionality and a storage to execute the method. The terminal device can be a communication terminal such as a mobile telephone, wherein the communication functionality may be provided by a usual optical telephone display, or by a speaker of the ear piece or the alarm tone generator of the mobile telephone. The communication functionality can be e.g. a display for displaying SM (Short Message), MMS (Multi Media Message), speech output etc. The method comprises detecting an initiation event in said terminal device. The type of the initiation event can be a timer, the detection of a simulated or a real message, a sensor input or a change in the settings of the terminal device, the activation of the simulation, a sensor signal of an environmental sensor and the like. The initiation event is recognizable and accessible by the simulation, but is not necessarily to be rated as simulation relevant. According to an example embodiment of the invention an arbitrary signal can be used to add a random feature for the detection of the initiation event.

The method determines properties of said detected initiation event. The properties can be simulation relevant parameters. It is e.g. possible to execute said simulation in dependence of the actual charging condition of the battery of a mobile device, to optimize the standby time of the terminal device, to prevent that the simulation totally discharges a battery pack of the device. Additional properties can be the local time, a detected travelling speed for suppressing messages of the simulation in case it can be expected that the user is actually travelling or driving a car.

The simulation generates a simulated message related to said determined properties. Said message is generated from data stored in said terminal device. Said simulated message has an appearance such as a message which is usually receivable by said terminal device via said communication network The message can be in form of an E-mail, a SM (Short Message), a MMS (Multi Media Message), in the form of a simulated phone call, or in the form of a video sequence, depending on the capabilities of the terminal device.

The generated simulated message is then presented via said communication functionality. The message can be directly presented, or can be stored in a local inbox of the terminal device, wherein the presentation is restricted to a notification such a s “you got mail”, “1 (new) message received”, or as ringing tone or a storage in a local voice mailbox with a notification “You missed one call”. One advantage of the indirect presentation resides in the fact that the user is less disturbed by a mailbox entry he can retrieve if he has enough time and in the fact that the processing power of the terminal device might not be able to handle a real time voice data exchange.

The idea behind the simulation is to reduce differences between the simulation and reality. This simulation service concept outlines possibilities and properties of mobile simulations and applications that can communicate with the user using the natural functions of the mobile phone. The simulation uses the standard interfaces used by the terminal to exchange messages with a user, wherein the user can not recognize the simulation by means of the used communication channel, but only by means of the contents of the communication.

In another example embodiment said simulated messages are composed of data stored in correspondence with said determined properties and composing rules stored in said storage. Said stored data can be embodied as message components and message fragments which can be filled in with actual dates, times, names of the user, or of properties determined at the detection of the initiation event. The simulated message can be generated by filling in a form letter or form message with the name and date of an actual addressee (user of the terminal device). If the initiation event is the reception of a message from the user, more sophisticated approaches can use the information contained in the user message to build up the next simulated message.

In yet another example embodiment the method further comprises the opening of a timeframe after the detection of said initiation event, and presenting said simulated message after the timeframe has closed. The time frame can be opened between the detection of said initiation event, prior or after said generation of said message and prior to said presenting. The simulation is based on an intermittent communication between the user and the terminal device. The time frame can be used to prevent that the simulation runs out too fast. The time frame can be used to prevent that the simulation waits too long for an initiation event, which would e.g. happen if an initiation event can not be detected for a few months, so that the user totally forgets about the simulation running in the background of his terminal device.

In another example embodiment the method further comprises receiving data from a provider, said data comprising components, fragments of simulated messages and rules for generating said simulated message. By receiving simulation data from a service provider the simulation can be loaded to the terminal device, or can be updated and expanded with additional features to increase the realism of the simulation. Said set of rules can be embodied as a computer program for generating the simulated messages in accordance with predefined properties and composition rules. The composing rules can also be adapted to preferred properties of the communication such as length, information content of user messages received from the terminal device. It is also possible to transmit sections of the communication to a central server to provide new and user specific data and message components/fragments. Thereby the simulation can adapt its own vocabulary, semantic and dialect to the one of the actual user.

In yet another example embodiment of the present invention, said initiation event is a predetermined point of time. The point of time can be determined by a timer runoff, the detection of a predetermined date or other points in time. Provided that the simulation has found out the birthday of the user, the simulation can send birthday greetings in time. The simulation can remind the user of an actual wedding anniversary.

In another example embodiment of the method said initiation event is defined by a reception of a user input. The user input can be received via a user input interface, such as the normal ITU-T-telephone keypad with the possibility to type in SMS messages. It is to be noted that the user input should be expected in form of a typed in SM or in form of spoken sentences, if the terminal device has a speech recognition capability. The terminal device can also be capable of identifying the contents of MMS, and is provided with enough calculation power, even with a pattern recognition system, to exchange messages concerning the contents of e.g. digital picture or a fax received from the user. In case of a SM the accompanying reports and sending conformations can also be sent, to further increase the realism of the simulation. Generation of the reports may also be done using a timer to simulate the message transfer time in a communication network In case of a voice input, the phone can simulate the dialing tones followed by an announcement of the simulated local answering machine, e.g. with changing texts. So the voice input actually is disguised 100% like a real phone call. So the simulation may not only simulate the message but also the accompanying “transfer protocols” appearances. In case of a voice input this can also include a respective display changing from “connecting” to “calling” to “phoning”, using the native display language of the terminal device.

In another example embodiment of the method said initiation event is defined by a reception of a message from a provider. The message of the service provider can be an automatically generated updating message. The message of the service provider can contain a number of actual topics to increase the simulation authenticity preventing that the simulated communication partner seems to be uninformed or even ignorant. The transmission from the service provider can comprise background information that the simulation can exchange with the user.

In yet another example embodiment the method further analyzes and evaluates said initiation event. By evaluating the initiation event and the properties of the event, e.g. said received user input, e.g. the user input rate and time of day for the user input, the time between sending of a message and receiving an answer, the simulation can adapt its interaction rate to the communicative abilities of the user, thereby preventing that the simulation is perceived as inappropriate by the user. The simulation can analyze the content of messages from the user like the name, nicknames, by searching for expressions such as: “ . . . my name is jack”, or “friends call me Tom”. By such evaluations the simulation can find out the name, the job, age, hobbies, most loves music style and other user specific small talk topics.

In another example embodiment at least one of said simulated messages comprises at least one advertisement. The advertisements can be hidden in the messages by inserting message fragments like “have you already seen the new XY-Car?”, or such short phrases with brand names. The communication can comprise information about the capabilities of the newest communication terminal device. The simulation can thereby simulate verbal advertisement.

According to yet another aspect of the invention, a software tool is provided comprising program code means for carrying out the method of the preceding description when said program product is run on a computer or a network device.

According to another aspect of the present invention, a computer program product downloadable from a server for carrying out the method of the preceding description is provided, which comprises program code means for performing all of the steps of the preceding methods when said program is run on a computer or a network device.

According to yet another aspect of the invention, a computer program product is provided comprising program code means stored on a computer readable medium for carrying out the methods of the preceding description, when said program product is run on a computer or a network device.

According to another aspect of the present invention a computer data signal is provided. The computer data signal is embodied in a carrier wave and represents a program that makes the computer perform the steps of the method contained in the preceding description, when said computer program is run on a computer, or a network device.

According to yet another aspect of the present invention a communication network terminal device for executing simulated communication is provided. The terminal device comprises, a detection module, a determination module, a storage, a communication functionality component and a generation module.

The detection module is used for detecting an initiation event. The initiation event can be anyone of the events described in the preceding description, or in the description of the figures, or any other suitable initiation event or suitable combination of events, detectable by the detection module.

The determination module is connected to said detection module for determining properties of said detected initiation event. The properties of the initiation event can be arbitrary simulation relevant parameters, as described in the description of the method.

The storage for storing components of simulated messages, and other data is required to operate the terminal device. The storage module can be an exchangeable storage module such as a memory card or a smart drive. The storage module may be even a read only storage or memory device.

The message generation module or simulation module is connected to said determination module and to said storage module, for generating simulated messages from said stored components in correspondence with said determined properties of initiation events.

The communication functionality component is adapted for presenting said generated simulated messages. The communication functionality component can be an acoustical display, a static or dynamic optical display, or a display for any one or a combination of means corresponding to the five human senses. The communication functionality component can e.g. be a Braille-output to communicate with blind people, or use the vibration or ringing alarm and the Morse code to present a message. The invention is not to be restricted by the actual implementation of the kind of communication functionality component or display actually used. To increase the realism of the simulation the presentation should be restricted to the normal communication interfaces used in exchanging messages. The detection module, the determination module and the generation module can be implemented on a single integrated circuit to reduce the number of components in the terminal device.

In an example embodiment of the present invention, the terminal device comprises an interface module for receiving data comprising components of said simulated messages, pre-set properties and generation rules for generating said simulated messages. The interface can be a radio interface, a network interface or an interface for receiving or connecting to an exchangeable storage device such as smart cards, USB keys and the like. The interface can comprise communication modules, e.g. Bluetooth, WLAN, LAN, IR and other communication devices such as Internet interfaces, GPRS, GSM and UMTS and the following communication network standards may be used. The device can comprise different interfaces to receive the simulation program e.g. via the internet and a PC interface, an exchangeable memory device such as a smartcard a minidisk, a PCMCIA card and the like.

In another example embodiment of the present invention said terminal device comprises a mobile phone. In this case the user interface device and the communication functionality component are the actual ITU-T-keyboard, the phone display, the earpiece and the mouthpiece and the alarm generator of the mobile phone. The mobile phone application has many advantages, as e.g. the telephone is the most common, most spread and most trusted communication medium. The invention may also be incorporated e.g. in FAX machines, for exchanging faxes and in internet computers, simulating e-mails.

According to another aspect of the present invention a network device for providing data for generating a simulated communication to terminal devices is provided. The network device comprises a storage module, a communication module and a controller. The storage module is for storing generation rules for simulated messages, simulated message components and evaluation rules. The storage module stores simulation programs comprising different simulations, as described in the description of the figures. The simulation program can comprise different story or communication plots, different keyword libraries and different composing rule libraries. The storage can store different program adapted to different terminal devices.

The network device comprises a communication module for connecting to said communication network and to terminal devices, to transfer the simulation programs or applications to terminal devices connected to the network device via a communication network.

The network device comprises a controller connected to said storage module and to said communication module, for selecting or generating different simulation programs and transmitting them to said connected terminal devices. The different simulations can be generated from sets of simulated messages components, generation rule libraries, keyword libraries, and evaluation rule libraries for increasing the variability of different simulations.

In the following, the invention will be described in detail by referring to the enclosed drawings in which:

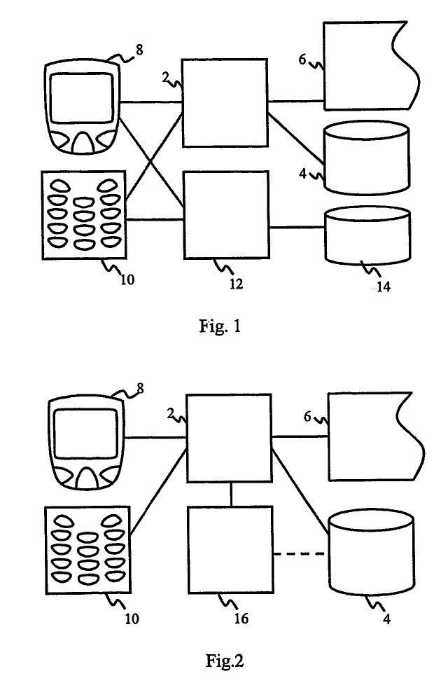

FIG. 1 is a block diagram of a conventional game enabled mobile phone.

FIG. 2 is an example of a mobile terminal device according to one embodiment of the present invention,

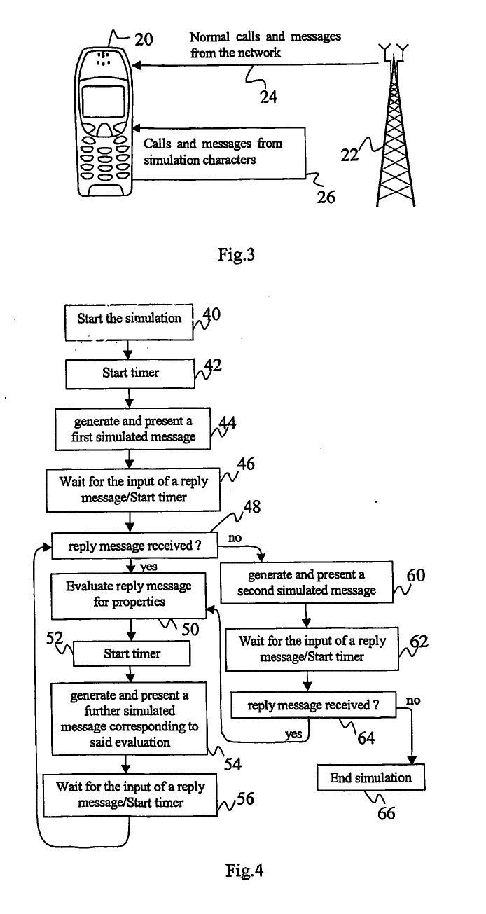

FIG. 3 is a block diagram showing the difference between normal and simulated communication, and

FIG. 4 is a flowchart of a simulated communication according to one aspect of the present invention.

FIG. 1 is a block diagram of a conventional game enabled mobile phone. A classic mobile phone comprises a main controller 2, a storage module 4, an interface 6 and a user interface comprising a display 8 and an ITU-T-telephone keypad 10. The gaming applications are usually embodied as a separate game unit 12 having a separate storage 14. So a user can access the game via selected keys and follow the game on the display 8. In a conventional mobile phone there are no direct interfaces between the controller and the functions of the phone and the functions of the game. Basically, the functions are well separated without any interfaces, thereby ensuring that no interference between the two functional units occurs. In a conventional in phone game, the user is always aware of actually gaming, as the display of the game is totally different from the display of the telephone in a normal mode. Such structures are well known from games such as “Snake”, “Space”, “Pairs”, etc.

FIG. 2 is an example of a mobile terminal device according to one embodiment of the present invention. In contrast to the conventional mobile phone, the simulation unit 16 of the invention uses no direct connection between display and keyboard and the simulation unit 16. The simulation unit 16 is directly connected to the controller of the mobile phone and to native functions of the mobile telephone. The simulation unit acts like a remote control providing a simulated network and a simulated communication partner. In the picture, the communication unit is directly connected to a storage 4 of the mobile phone, to store and retrieve simulation relevant data. The simulation requires a lot of data and therefore a lot of storage space, so it would be a waste of resources to provide a great separate storage for a unit which is not necessarily used. Previously, this kind of simulation has only been available over the network. There have been servers that send SMS messages of simulation events and even call servers that play back recorded simulation messages. The reality simulation concept essentially brings the same simulation type to the local device, where running the simulation does not incur any costs to the user.

Regardless of programming language the application programming interfaces, or APIs (Application Program Interface), in the phone determine the capabilities of simulations and applications.

In a basic implementation the reality simulation will be permanently stored in the user's phone. The simulation could use random data or different simulations for variation. However, it might also be possible to download new reality simulations and applications to the phone from a network.

Being able to download new simulations would create many possibilities for new types of simulations and applications that can utilize the native phone interface when communicating with the user.

The reality simulation essentially requires access and capability to produce some of the native events of the mobile phone. Whereas a current game works by reading keypad events and updating the phone display accordingly, the reality simulation also needs access to other components like the phone SMS inbox and incoming call activation. The reality simulation also needs access to components like the phone SMS outbox to intercept incoming messages addressed to the simulation. The simplest way to introduce these capabilities is to add API calls to the phone software that allow placing a given text string as a SMS message into the SMS inbox of the phone. MMS (Multi-Media-messages) messages could be added in the same way, with an option to include picture or a sound clip in the message. The simulation could use these API calls to deliver messages to the local user.

When the user answers this kind of software-generated message, the phone software would intercept the message and relay it to the simulation instead of sending it to the network. The simulation can adjust its behavior based on the contents of the message that the user sent. Another API call could be used to make the phone ring as if someone is calling and display a given simulated caller name on the display. When the user answers, a sound clip given by the calling application would be played back. An advanced implementation could also allow the application to listen to the user answering and process the sound, trying to understand what the user is saying.

There is no need of a full access to all services—for example, the API might only allow the simulation to add a new SMS message to the inbox and not view or delete anything. The user would be notified of the new message like he is notified of any other incoming SMS. If it is seen necessary for the simulation to read the user's phonebook for names or add appointments in the phone calendar, the phone software needs to have local API calling for these functions also. The simulation can use an API call to read the list of names and another call to add a new appointment to a given date in the calendar.

The API calls in the phone software define what the simulation application is allowed to do—if there is no API call to read the phone numbers of people in the phonebook, the simulation can not do so. An API to access some of the local phone features should be designed, possibly even standardized. The local feature API should of course take security issues into account, so that the simulation can not perform any hostile actions on the user's data.

An alternative implementation approach to access phone features would be to just simulate them. Once the simulation is started, it can display a screen that looks like the phone stand-by screen. In reality, however, the simulation is running and controlling the whole screen. The simulation can simulate incoming calls or SMS messages at will. There are, however, many drawbacks to this approach. In this type of implementation the simulation is strictly separated from the normal use of the phone. If a real-life friend calls the user, the simulation can't show the call and must either exit or suspend itself for the duration of the call. The simulation has to be customized for every phone model to make it look like the native phone display. This approach to implementation is more lightweight, since there are no changes to the phone software API required. However, the simulation would still need some kind of multimedia API for the simulation to be able to play back digital sound clips.

Another point in the simulation would be that more or less vital information of the standby display may be incorporated in the display of the simulation, so that the user can see the actual condition of the battery or the actual base station signal strength, to prevent that a user wastes battery power by trying to connect to a base station actually not available.

The reality simulation needs to be able to run in the background on the phone, only performing activities and alerting the user when it needs attention. The phone should have the capability to “minimize” the simulation but leave it running. Depending on the simulation or application, it might perform e.g. some simulation-related heavy data processing jobs while it is in the background, or it might just suspend itself and set a timer to wake it up at some defined future time.

Since the reality simulation can have access to the native features of the phone like the names in the phonebook or the calendar of the user, it will probably be necessary to restrict the network access of the simulation. Otherwise, a hostile simulation could e.g. send the phonebook out to the Internet and other people, which would be a serious breach of privacy.

The reality simulation concept itself does not need any network access, so it can be blocked altogether. The phone software should enforce this, so that if an application has e.g. read the phonebook, it will not be allowed further network communication.

FIG. 3 is an illustration of incoming calls and simulated messages. One important aspect of the reality simulation is that instead of the phone keypad and display, the simulation uses the native user interface of the phone 20 to communicate with the user. For example, the simulation can send SMS (or MMS) messages, or call and even talk 26 to the user when the user answers. The actual simulation progress is determined by the user actions, like answering calls and responding to messages. No calls are placed or messages sent over the telephone network 26—the simulation is generating and interpreting them locally inside the mobile phone. This type of user interface makes sense, since the phone is primarily designed for calling. The standard functionality of the phone 20, to communicate 24 over an air interface with a base station 22 of a cellular telephone network is left unchanged.

FIG. 4 provides a very simple and clear example embodiment of the present invention, wherein a correspondence between two chess partners is outlined. It is to be noted, that the point of the invention is neither chess, nor the chess program, but the simulation of the chess partner itself. In this example chess is only the topic of the simulation. Classical correspondence chess is played via letters and rarely via telephone, and modern check partners may use the SMS (Short Message Service) of modern mobile telephone networks. The basic idea is to simulate the chess partner by a locally stored chess program in the telephone, exchanging the single moves in an intermittent way. This includes several advantages: the calculation power of the telephone can be very low as the time required to produce a respective answer can be very long, e.g. between a few hours and a few days, the user is urged to answer the simulated messages every now and then. Thereby it is guaranteed that the user keeps playing chess, or keeps following one of his hobbies, preventing hat the user abandons his hobby because of lacking time or simply forgetting to play.

The simulation can be activated by the user by starting the corresponding option in a menu in his mobile phone. The excitement of a normal chess game session only lasts for a short while, and the user usually decides for himself that he is going to play a certain game on a chess computer for a few moments and stop after the game is over. This concept, on the other hand, describes mobile simulations that are not as tied to the choices of a user and are not limited by his will or time to play. The concept is a reality simulation. The reality simulation is a little like the Nokia Game that has been running in recent years, but without the Internet or any other communication network. Instead, the reality simulation runs only locally on the phone and is played by a single user. When the user starts the reality simulation on his mobile phone, it just says that he has started the simulation.

Nothing else happens at this point, but the simulation is now running silently in the background. The user can go about his normal business until something happens in the simulation. Then, the simulation in the mobile phone generates a message to the user which is expected to be used in starting a correspondence chess game, simulating a person wanting to play correspondence chess. The first message can e.g. be “Hello, here is Jack, do you want to play a game of correspondence chess?”. This can be a previously stored opening message, stored in a storage in the telephone which is simply retrieved on the activation of the chess simulation. Another message could be “Hi “###”, want to play again?”+“it has been long since the last game of chess”. The point of the invention is that the message the user receives looks like an authentic short message from a real chess partner, and not just like a simple chess computer display. The message can be embodied as a normal-looking phone call, but it is in fact the simulation generating the phone call event. When the user picks up the phone, the simulation starts talking or interacting with the user. The simulation can naturally be localized to the user's native language, so that the user can understand what the simulation character is saying. The simulation can naturally be localized to a foreign language, so that the simulation can simulate a conversation with a person in a foreign country. This concept has two major advantages: The user is kept off from tying to visit the virtual characters, and orthographic and semantic restrictions in the conversation can be attributed to a small vocabulary of the virtual foreign tongue character.

The reality simulation runs on the phone and uses the native user interface to communicate with the user. This makes the simulation interface transparent to the user—instead of pressing number keys to control a game and seeing some game actions on the phone display, the user interacts with the simulation by using normal phone features. Many current games try to simulate some part of reality, like driving a car or flying a spaceship, but the reality simulation concept goes further than that. The simulation exactly simulates real life, so it feels more authentic. The simulation can even introduce new virtual friends (simulation characters) to the life of the user if he would otherwise get only a few phone calls. The distinction between the simulation and reality starts to blur.

To achieve a reality component, the simulation program depicts the message with the standard display used for indicating a received message. This can be done by not directly displaying the message itself to the user, but displaying a screen similar to the “1 message received” displays on the telephone. The user has to press the usual buttons in the usual manner to display the simulated message on the screen of the phone. The usual procedures help to smudge the border between the simulation and the reality, as the messages and the telephone behave like in reality, and the use is holding his very own real phone in his hands, it is expected that the perceived reality may really lead to a perfect simulation. It is not intended to display a tiny chessboard with even more minute chess pieces requiring a magnifying glass on the display, but simply exchange the moves so that a user can play the game on a real chessboard at home. All tracks that the present simulation is executed by a computer has to be covered up, to increase the quality of the simulation. It is proposed that the user writes down the single moves to be able to reconstruct the game.

The user is supposed to answer with a message like “OK”, “Yes” or “Yeah” or other keywords like “No”, “Not again”, “get out of my life”, “later, in 2 weeks”. The simulation further can search for key sequences like “ . . . I . . . white . . . ” or, or “ . . . I . . . begin . . . ” followed by an announcement like “P2d-4d” or a “K1b-3c” to start the game with a prawn or a knight. Alternatively, the simulation can receive keywords such as “ . . . You . . . begin . . . ”. “ . . . you . . . white . . . ”. In the following the simulation can generate a message composed of text fragments like “Looks like it is going to be a classical opening:”+“P7g-5g”, or the like. The simulation can comprise different aspects of a classical chess game and rudimentary conversation elements to increase the reality of the simulation. The text fragments can be stored in a library to simplify the generation of more complex conversation elements. The simulation can spice up the conversation with chess problems, or questions to the average number of games the user plays per week, to adapt the difficulty of its game to an expected strength of the user. As has been seen, this simple example of a “correspondence less” correspondence chess is very good suited to illustrate the basic functions of the simulation on a mobile phone.

It is further to be noted that the simulation can be implemented as a local computer program that can be stored on the terminal device and can, but need not to be updated with data from a server. If the simulation requires a direct connection to a service provider for a data update the simulation can request the user to call or notify a service provider by means of a telephone call, or by means of a SM. The number of required updates should be low compared with the number of exchanged simulated messages. So no direct communication costs occur, as compared to the SMS costs of a real correspondence chess game. So the simulation can economize the chess partner and the communication costs, which can get quite high in regard of the number of moves that are possible in a single chess game. This example provides a local correspondence chess which makes the simulation very cheap.

In this example the mobile telephone has a simulation entity that is able to generate a number of messages in a way similar to the conventional messages. It is therefore possible to connect the output of the simulation unit with the inbox of the message box. So the simulation unit simply transfers the message to the inbox of the telephone and let the telephone alert the user of a received message. This embodiment requires a close constructional interface between the simulation unit and the vital functions of the telephone. It should be noted that the simulation should e.g. not be able to send a message in certain time frames such as between 10:00 p.m. and 8:00 am, to prevent that the user is seriously disturbed during the night and might get angry over the simulation. Another advantage of the above described implementation of a direct connection between the message inbox and the simulation unit would be that the phone automatically suppresses the alerting of the user in case of a “silent”- or “meeting”-mode of the mobile telephone.

The simulation unit can also be directly connected to the outbox of the telephone if the outbox is capable of directing the message directly to the simulation unit by a predetermined unique telephone number code, comprising e.g. a number of “+” and “#” characters. Alternatively, the simulation can use the serial number of the phone or the SIM card to provide a twenty-character “simulated” telephone number further increasing the realism of the simulation. This would increase the realism, as the simulated communication is done via a telephone number in the phone book of the mobile phone. So basically the simulation can be implemented with basic mobile telephone features to reduce the hardware elements necessary to run the simulation.

Another application could e.g. be a communication trainer, for training a foreign language, by means of a virtual communication with a virtual person on the terminal device. Dependent on the processing power of the terminal device, the quality and complexity of the communication can be increased. A low level communication trainer can be used for not totally loosing the touch with a foreign language. This application can also simulate a pen friend. A more sophisticated version could be a simulated phone friend, for exchanging voice messages. In difference to “tamagoshis” the present simulation hides the fact that being a simulation.

A more sophisticated embodiment of a simulation can comprise the following steps: Receiving an offer from a provider to the mobile terminal device to provide the user of the terminal with simulated messages, as one method to transfer the whole simulation to the terminal device.

Without restriction of the general applicability it is assumed in the following that the terminal device is a mobile phone with a superior processing/calculation and storage capability.

If the user transmits a respective message back to the provider, the user transmits an accept message to the provider, the provider sends a simulation program, a set of simulation data and additional information to the mobile phone. The program can be in a simple embodiment a kind of role play between a user and a virtual person.

To further increase the level of simulation the transferred information can further comprise additional information about the user such as christian name, surname, age, job, address and average income or average communication rate, number of different communication partners and all such information available by a service or net provider such as a telecom service.

The simulation can also be transferred to the telephone by means of an interface to a personal computer with a connection to the internet, or by means of an interface to a connectable storage device such as a smartcard, a USB (Universal Serial Bus) memory key, a PCMCIA memory card. The simulation program can also be stored on the terminal device by the manufacturer such as other application programs. The exchangeable storage device has another big advantage: it can be used with different mobile terminal devices, so if a long time simulation may exceed the lifetime of a mobile phone the user can continue the simulation on his new phone, by exchanging the pluggable memory. Another advantage is that users are urged to brand loyalty, to keep a long time simulation running. The program can be a Java™ program so it can be run on nearly every terminal device with sufficient processing power.

The simulation can be activated or started 40 by a user input, e.g. in a respective menu in the telephone control or setting menu. Then, the simulation can start a timer 42 to delay the actual start of the simulation to cover up a causal relationship between a first simulated message and the start of the simulation.

After the timer has run out, a first simulated message is generated and presented 44. The presentation of the message could be a direct presentation (in case of an acoustical message) or an indirect message (in case of a SMS or MMS) notifying the user that he has received a message. The message can be written into the inbox of the messaging system in the telephone, or in case of an acoustical message into a voicemailbox within the mobile phone.

The first message can comprise typical first greetings like “hello this is “###””+“Question element for name”+““Retrieve Phone Book entry No. 7” gave me your number”. Actually it seems to the user that a person is calling. So one feature is that it seems that the telephone is taking the first step in the simulation, which also increases the realism of the simulation. It is actually not known that a simulation can make the first step of an interaction.

With the presentation of the message a timer can be started, to ensure that the user is actually replying, and willing to use the simulation.

The user is supposed to answer 48 this question with a text including keywords or key passages like “my name is ###”, “ . . . my friends call me “###”” or “here is ###”, and such key sections. The program extracts 50 this name information and stores it in a storage to improve the simulation quality. This enables the simulation to add a personal feature to the following simulation, increasing the realism.

After having established a first contact, the program starts a closed loop 48 to 56 with alternating simulated messages and respective replies from the user.

In the closed loop the, messages can be personally directed to the user, and can use the first name of a user, to execute small talk or personalize the simulated messages. The simulation can be used to simulate more and more sophisticated levels of personal communication with an increasing number of information received from the user. The virtual communication can comprise the generation of a more complex virtual communication partner with an increasing and self adapting virtual person in the terminal device. The simulation can pretend to be of a similar age and can pretend to have a short but an easy to remember name. The name could e.g. be a unisex nickname like “Joe”, “Lex”, “Nick” “Chris”, which can be written out as “Joe” or “Joanne”, “Alex” or “Alexia”, “Nicholas”, “Nikkita” or “Nicole” or “Christian” or “Christina”.

This feature involves the main advantage that the simulation can adapt its own virtual sex to information like, if the user is male or female, or if the user is married or single. This can avoid jealousy or problems between a married couple and the simulation. The simulation can simply find out by sending a message like “greetings to your wife and children”. A reply message should therefore comprise a key sequence like “her name is ###”, “not wed”, or keywords like “divorced” or “maintenance”.

A surname is less important and can be a very rare or a very common name such as “Smith”, “Garumont”. It can be possible for the simulation to access all names in the phonebook of the terminal device—it can use e.g. the names for simulation characters, for example. This would instantly personalize the simulation to the individual player's local environment. This feature can lead to great confusion, if the simulation sends a message in the name of a phonebook entry, so it would be better to generate new characters from names actually not present in the phonebook, and to add these new character with named and virtual phone number to the phonebook. Of course, the simulation can only read phonebook and maybe generate phone book items, but is not to be enabled to edit or remove them.

The message is generated in the phone itself, and therefore not restricted to the reception or the availability of a communication network. The program for generating the simulated messages can be set to a sleep mode to save energy if the program is actually not receiving an initiation event. The program can be activated e.g. by a timer function, activating the simulation in irregular intervals. Acting like a regular paid news service, the simulation can send local MMS messages to the user. The messages can contain pictures, video, sound and information about the simulation progress. For example, a friend (actually the simulation) could send a MMS message that includes a picture “he just took”—with the picture showing a strange light formation up in the sky.

In the case that no reply is received from the user within the timeframe set at 46, the simulation can generate a simulated request 62 if the user wants to go on with the simulation. Preferably this message is also connected to a (longer) timeframe, and may be repeated for a few times. the generated message can be a very personal one, if the simulation should not directly reveal itself to be a simulation, or can be a simple message like “Want to continue the simulation? Y/N”.

In case the simulation receives a “N” message 64, the simulation can be terminated. In case of no reply the terminal can be terminated 66 e.g. after 4 or 5 weeks (the maximum time a user is supposed to be on vacation and has forgotten to take his mobile phone with him). In case of a received “Y” message, the simulation can return to the normal closed loop 48 to 56. The simulation can also be terminated by a respective user input in the control menu of the mobile phone.

It should be noted that the outlined example can be varied e.g. by inserting branches so that the simulation sends two or more messages in sequence before expecting a next message. Another variation can be to skip the generation of one message, so that the user has to ask about the last message, followed by a formal apology from the simulation.

Basically the present simulation provides a method for generating and executing a lively simulation of communication partners. The simulation running on a mobile phone is allowed to call the local user or send text or multimedia messages to him. The simulation would run on the phone in the background, and when it needs the user's attention, it could use the phone's native functions to get it. When the user answers the simulation that is calling him, the simulation could also talk back. There is no actual network communication required, since everything happens locally on the phone—although they seem real, the calls and arriving messages are actually just simulated.

In a future simulation the phone can collect all responses of the user and transfer the whole communication between the user and the simulation to a service provider to increase the realism of future generations of simulations, so that the speech, the reactions of a future simulation can be adapted to the real behavior of people. Thereby the restrictions of the simulation due to the limited fantasy of human programmers might be overcome.

The simulations themselves should be sensitive and responsive to what comes to be an actual simulation content. Users may be shocked if they receive a sudden phone call that their (simulated) friend is in the hospital. Even worse, this might cause the same effect that the boy who falsely alerted townspeople of a wolf did—people might become ignorant of actual emergencies. It should also be taken into account that in case of an emergency, the user might inversely call the simulation for help regarding the simulation as a real person. The simulation might be enabled to recognize emergency keywords and emergency indicating environmental conditions to automatically call for help, if a respective message containing a SOS or other emergency specific keywords is received from a user.

For example, a person could suddenly call the user and tell that he sees a UFO in the sky, or someone could send a message to the user that he or she wants to be more in touch with the user. The simulation characters can feel very real for the user, since the simulation and the user are talking and sending messages like any real person would. As it progresses, the simulation would attempt to create the action or drama in life that many people seem to be missing.

A major concern is that if the simulation is given control of phone functions like calling the user, accessing the phonebook and similar things, security risks may arise. A rogue simulation might cause some trouble if it can tap the phone's controls too deeply. For example, if a hostile simulation can continuously place calls to the user, it would hamper the usability of the phone.

Users might not even know that they are in a simulation and they might think that they are getting crank calls when the simulation is running. There is certainly a risk that users will not appreciate the simulation being able to call them from time to time, and therefore it must be easy to turn off the simulation at will (e.g. via a control menu in the telephone). It is also possible to mark the simulated messages by depicting a small icon on the display, or by an outline box, to prevent that the user looses his sense for reality, and gets lost in a too real simulation.

From a technical point of view, a reality simulation package will likely require quite a lot of storage space, since it must store simulation data locally on the phone. If the simulation includes many sound clips and multimedia messages, it can become quite large. Available storage space will dictate how complex this kind of simulation application can be. Combined with an artificial intelligence, the simulation may itself learn and adapt its own capabilities to the ones of the user.

Note that although this concept mostly describes a simulation application, the same principals can be used for any type of application. Business applications like a local personal secretary simulation application could also benefit from being able to call the user and remind him of appointments. Phone calendar entries could serve as a journal in the simulation. The user can check the calendar to remember what happened and when. Calendar entries can be added automatically by the simulation, so the user will not need to keep a journal himself. Additionally, the simulation could add calendar entries or to-do list entries to indicate future simulation happenings. Actually the simulation can add calendar entries to the mobile phone, if the simulation messages and storyline mention e.g. a (virtual) funeral or other important happening, this could be generated in the calendar. This feature can decrease the level of realism, as no real person would be able to predict the future, and since no real person can add entries to the user's phonebook for him.

The reason for using or requesting the simulated messaging is not relevant for the present invention. It can be used as a support for learning or training a foreign language, as pass time or as a kind of an interactive game, or even as a mixture of these features, as an interactive foreign language training simulation for example. Other applications of the above method and device would be to increase the authenticity of a role playing game. The invention can also be used to execute strategy or simulation programs such as a portable version of the “Sim city” or the “Tanaland”—developing country simulation. Another application would be to generate a kind of reality-type simulation wherein a normally trusted information source turns to generate a virtual reality, such in the case of the first broadcast of H. G. Wells' “War of the Worlds” radio play, transmitted as standard news in the radio without mentioning it has been a radio play. Another important application is to provide the user of a mobile phone with a lots of advertising hidden in the simulated messages as a new way of delivering many ads to a mobile phone, without the need to use the communication network repeatedly. The invention is more than a single idea but the foundation of a whole new applicability of mobile terminal devices.

The simulation can access the user's phonebook and calendar, but the simulation should not be enabled to connect to the network alone at all. A connection request to the user that has to be confirmed could be a possibility to automatically connect to a service provider for a data update. The reality simulation concept described here is meant only for local phone use, even though it appears to the user as if he was getting phone calls and instant messages from other people over the telephone network.

The user can choose to terminate, hold or pause the simulation at any time, to keep it from disturbing the normal use of the phone. Since the simulation can feel very real, it is important to offer an easy way out. This can e.g. be done by a menu option in the settings of the terminal device or by a respective unambiguous message to the simulation.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. A method for simulating communication on a terminal device of a communication network, said terminal device comprising a communication functionality and a storage, the method comprising:
detecting an initiation event in said terminal device,
determining properties of said detected initiation event,
generating a simulated message related to said determined properties, said message being generated from data stored in said storage, and
presenting said simulated message via said communication functionality.

2. The method according to claim 1, wherein said generation step comprises composing said simulated message from said data in correspondence with said determined properties and composing rules stored in said storage.

3. The method according to claim 1, further comprising opening a timeframe after the detection of said initiation event, and presenting said simulated message after the timeframe has closed.

4. The method according to claim 1, further comprising receiving data from a provider, said data comprising components, fragments of simulated messages and rules for generating said simulated message.

5. The method according to claim 1, wherein said initiation event is a predetermined point of time.

6. The method according to claim 1, wherein said initiation event is defined by a reception of a user input or the reception of a message from a provider.

7. The method according to claim 1, further comprising analyzing and evaluating said initiation event.

8. The method according to claim 1, wherein at least one of said simulated messages comprises at least one advertisement.

9. A software tool comprising program code means stored on a computer readable medium for carrying out the method of claim 1 when said software tool is run on a computer or network device.

10. A computer program product comprising program code means stored on a computer readable medium for carrying out the method of claim 1 when said program product is run on a computer or network device.

11. A computer program product comprising program code, downloadable from a server for carrying out the method of claim 1 when said program product is run on a computer or network device.

12. A computer data signal embodied in a carrier wave and representing a program that instructs a computer to perform the steps of the method of claim 1.

13. A network terminal device for executing simulated communication, comprising:
a detection module for detecting an initiation event,
a determination module, connected to said detection module for determining properties of said detected initiation event,
a storage for storing components of simulated messages,
a generation module, connected to said determination module and to said storage module, for generating simulated messages from said stored components in correspondence with said determined properties, and
a communication component for presenting said generated simulated messages.

14. The network terminal device according to claim 13, comprising an interface module for receiving data comprising components of said simulated messages and generation rules for generating said simulated messages.

15. The network terminal device according to claim 13, wherein said terminal device comprises a mobile phone.

16. A network device for providing data for generating a simulated communication to terminal devices comprising
a storage module for storing generation rules for simulated messages, simulated message components and evaluation rules,
a communication module for connecting to said communication network and to said terminal devices, and
a controller connected to said storage module and to said communication module, for selecting sets of simulated messages components and generation rules for transmitting said selected sets to said terminal devices.
